(19) United States
(12) Patent Application Publication
(10) Pub. No.: US 2026/0231910 A1
(43) Pub. Date: Aug. 13, 2026

(54) APPARATUS AND METHOD FOR FISH TAGGING

(71) Applicant: Oregon State University, Corvallis, OR (US)

(72) Inventors: Michael A. Banks, Corvallis, OR (US); Drummond Wengrove, Corvallis, OR (US); Rahul Kumar Nalubandhu, Corvallis, OR (US); Spencer Tanenholtz, Corvallis, OR (US); David P. Jacobson, Corvallis, OR (US)

(73) Assignee: Oregon State University, Corvallis, OR (US)

(21) Appl. No.: 19/155,233

(22) PCT Filed: Feb. 23, 2024
(86) PCT No.: PCT/US2024/017000

§ 371 Date: Aug. 8, 2025

Related U.S. Application Data
(60) Provisional application No. 63/486,983, filed on Feb. 25, 2023.

(51) Int. Cl. A01K 61/95

(52) U.S. Cl. CPC A01K 61/95

(57) ABSTRACT

Disclosed is an apparatus and method for fish tagging. In at least one example, the apparatus comprises: a tunnel having a length extending between a first opening and a second opening; a motion sensor positioned on or within the tunnel at a first distance from the first opening, wherein the first distance is a portion of the length; a punch comprising a shaft, wherein the shaft comprises a tip and extends transversely into an interior region of the tunnel through an upper wall of the tunnel at a second distance from the first opening. The punch is coupled to an actuator coupled to the upper wall of the tunnel. and an anvil coupled to a lower wall of the tunnel below the tip of the punch. The anvil comprises a third opening aligned to an axis of the punch.

### CLAIM OF PRIORITY

This application claims priority to U.S. Provisional Application No. 63/486,983, filed Feb. 25, 2023, which is incorporated by reference in its entirety.

### BACKGROUND

Fish hatcheries continue to play a pivotal role in maintaining life history diversity among wild salmon, which are an important component of the global ecosystem. Tagging programs are commonly conducted at fish management stations such as fish hatcheries on land or fishing vessels at sea. Tagging programs are designed to gather genetic and biochemical data on fish populations by extracting tissue samples from living or dead fish. It is challenging to gather and archive individual tissue samples from the thousands of salmon that can occur en masse at hatcheries or fishing vessels. For personnel tasked with managing tagging programs, there are generally too many fish to achieve successful processing within the time available. This time is already fully extended because of other tasks and processes that need to be achieved efficiently to sustain the function of the context at hand. For example, thousands of fish in hatcheries need to be ‘worked’ efficiently before they lose the quality or vigor necessary for other commitments at the hatchery, such as release back into the wild, spawning, or processing for industry or food share.

As another example, the efficiency of processing and cold storage among fish on a fishing vessel or a processing facility is a significant parameter of maintaining top market value. For example, coder-wire-tags, placed in the heads of millions of hatchery salmon are expensive because of their large number and tagging robotics required to implement them. This method also suffers substantial loss, because on average only 2% of hatchery fish return. For tagging constraints to remain cost effective, unacceptable expansion errors in forming estimates may be a consequence.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical implementations can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1A illustrates a profile view of a tissue sampling apparatus, in accordance with at least one example.

FIG. 1B illustrates an end-on view of tissue sampling apparatus shown in FIG. 1A, in accordance with at least one example.

FIG. 1C illustrates a profile view of tissue sampling apparatus 100B, in accordance with at least one example.

FIG. 2A illustrates a profile view of a tissue sampling apparatus, in accordance with at least one example.

FIG. 2B illustrates an end-on view of tissue sampling apparatus 200, in accordance with at least one example.

FIG. 3A illustrates a block diagram of a control system for a tissue sampling apparatus comprising a pneumatically-driven punch shown in FIG. 1A, in accordance with at least one example.

FIG. 3B illustrates a block diagram of a control system for a tissue sampling apparatus comprising a linear drive punch, in accordance with at least one example.

FIGS. 4A-4F illustrate a sequence of exemplary method steps for operation of a tissue sampling apparatus, such as tissue sampling apparatus shown in FIG. 1A, in accordance with at least one example.

FIG. 5 presents a flowchart recapping method illustrated in FIGS. 4A-4F, in accordance with at least one example.

FIGS. 6A-6E illustrate a sequence of operations of a method of operation of a tissue sampling apparatus, in accordance with some examples.

FIG. 7 illustrates a flowchart recapping method illustrated in FIGS. 6A-6E, in accordance with at least one example.

FIG. 8 illustrates a computer device (also referred to as a computer system), in accordance with some implementations.

### DETAILED DESCRIPTION

Disclosed herein is an apparatus and method for fish tagging that may have many advantages over current tagging methods applied in industry, in accordance with at least one example. In at least one example, a method, in association with parent-based tagging, has substantial savings because DNA from two parents may be passed to all 3-5,000 offspring for free, and expansion errors do not occur, because all fish carry DNA. In at least one example, a method takes advantage of fact that DNA from just 2 parents will effectively tag all 3-5,000 of their offspring at no additional tagging cost.

A In at least one example, a fish tissue sampling apparatus is described. In at least one example, an apparatus comprises a tunnel into which fish may be introduced and sampled. In at least one example, the tunnel may be tilted so that fish may slide down the tunnel under influence of gravity from an entrance opening to an exit opening. In at least one example, fish may be sampled while transiting tunnel by a tissue punch that may be automatically triggered when a fish is detected at entrance of tunnel. In at least one example, tail fin of fish may be sampled. In at least one example, punch comprises a cutting tip that may cut a tissue tag from tail fin of fish when punch is driven to fin. In at least one example, fin may be supported on an anvil that enables punch tip to penetrate fin tissue and cut a tissue sample as it passes through fin. In at least one example, an anvil comprises a hole that opens to a collection vessel, such as a collection bottle or jar. In at least one example, tissue tag may be dropped into collection vessel. In at least one example, compressed air pulses may be introduced at mouth of collection vessel to blow tissue tag off punch tip.

In at least one example, punch actuator may be triggered by a motion sensor that may be located near an entrance of tunnel. In at least one example, motion sensor may be an optical detector and light source. In at least one example, optical detector may be an infrared detector. In at least one example, light source may be an infrared source. In at least one example, the motion sensor may be acoustic. In at least one example, motion detector may be a video camera. In at least one example, the motion sensor may be electrically coupled to a controller. In at least one example, the controller may be electrically coupled to punch actuator. In at least one example, controller may be operable to receive a detection signal from motion sensor and to send a control signal to punch actuator. In at least one example, punch actuator may be timed to activate punch after a predetermined interval following initial detection, allowing fish to travel a distance down tunnel so that its tail fin may be positioned over anvil.

In at least one example, the tunnel comprises a second exit opening. In at least one example, tunnel comprises a movable partition that may be positioned to block first exit opening or second exit opening. In at least one example, a metal detector may be included within the tunnel to monitor fish for metal tags embedded in their bodies. In at least one example, the metal detector may be electrically coupled to a controller. In at least one example, the controller may be electrically coupled to a partition actuator, enabling automatic positioning of partition based on a detection signal from metal detector. In at least one example, if a metal tag is detected in a fish, partition may be actuated to block first exit opening and enable fish to pass through second exit opening. In at least one example, fish having metal tags may be collected in this manner and processed to remove metal tags.

In at least one example, apparatus and method may enable collection of tissue samples from thousands of salmon per day without interrupting normal operations already established in most hatcheries. In at least one example, because parent-based tagging allows identification of all offspring, applications with disclosed apparatus and method may overcome estimate expansion, straying and other behavioral uncertainties associated with metal and other tagging methods applied to assist current hatchery management.

Here, some methods and devices may be shown in block diagram form, rather than in detail, to avoid obscuring present disclosure. Reference throughout this specification to “an example” or “one example” or “some examples” means that a particular feature, structure, function, or characteristic described in connection with an implementation is included in at least one example of disclosure. Thus, appearances of phrase “in an example” or “in one example,” “in at least one example,” or “some examples” in various places throughout this specification are not necessarily referring to same example of disclosure. Furthermore, particular features, structures, functions, or characteristics can be combined in any suitable manner in one or more examples. For example, a first example can be combined with a second example anywhere particular features, structures, functions, or characteristics associated with two implementations are not mutually exclusive. A list of definitions follows, whereby following definitions may provide or augment literal support for claims.

Here, “tunnel” may generally refer to a tubular structure tilted at an angle with respect to vertical, so that objects placed with tunnel transit tunnel under influence of gravity. In at least one example, a tunnel comprises a wall surrounding a hollow interior space or region.

Here, “tubular body” may generally refer to an elongated hollow structure having a length extending between a first opening and a second opening. In at least one example, a tubular body may have a circular cross section or a polygonal cross section. In at least one example tubular body has a hollow interior region.

Here, “wall” may generally refer to a shell of a tubular body surrounding a hollow interior region.

Here, “exterior surface” may generally refer to an outer surface of a wall of a tubular body of a tunnel.

Here, “interior surface” may generally refer to an inner surface of a wall of a tubular body of a tunnel.

Here, “interior region” may generally refer to a hollow center region of a tubular body. In at least one example, an interior region may be a hollow interior of tubular body.

Here, “opening” may generally refer to an open port at either end of a tubular body.

Here, “motion sensor” may generally refer to a device operational to detect motion of an object in vicinity of motion sensor. In at least one example, a motion sensor may be an optical detector. In at least one example, a motion sensor may be an acoustic sensor. In at least one example, a motion sensor may be positioned on or within tunnel at a distance from first opening.

Here, “distance” may generally refer to a portion of length of a tunnel.

Here, “punch” may generally refer to a device comprising a shaft, and a tip at end of shaft. In at least one example, a tip may comprise sharp edges for cutting or stamping a sheet of material. In at least one example, a punch may be employed to cut small tissue samples from fish parts.

Here, “shaft” may generally refer to an elongated portion of a punch.

Here, “axis” may generally refer to a central axis of shaft of a punch.

Here, “tip” may generally refer to an end of shaft of a punch. In at least one example, tip may have sharp edges for cutting through sheets of materials or tissues.

Here, “anvil” may generally refer to a sturdy flat platform on which an object may be set to receive blows from a hammer or punch. In at least one example, an anvil may be operational to support a tail fin of a fish enabling a punch to cleanly penetrate tail fin.

Here, “catchment” may generally refer to a container or object configured to intercept and hold tissue samples from the tip of a punch shaft. In at least one implementation, a catchment may be or comprise a receptacle for holding or storing tissue samples, such as a jar or bottle. In at least one example, a catchment may comprise a multi-well plate, a train of sample bottles, or a dry-storage card. With the exception of the dry-storage card, the catchment may contain a preservative fluid such as ethanol. In at least one implementation, a dry-storage card may a be a paper card or polymer card or plate operable to adhere to tissue samples for long term storage in a dry environment.

Here, “vessel” may generally refer to a container such as a jar or bottle. In at least one example, a vessel may be a receptacle for holding or storing tissue samples.

Here, “movable stage” may generally refer to a moveable platform. In at least one example, a movable stage may be actuated by piston drives to move vertically.

Here, “pneumatic actuator” may generally refer to a piston device that is driven by compressed air.

Here, “controller” may generally refer to an electronic circuit operable to control peripheral devices. In at least one example, a controller comprises a processor coupled to a memory.

Here, “signal” may generally refer to sensor signals as analog or digital voltages that are output from peripheral devices and received by a controller and output as control signals from a controller to peripheral devices.

Here, “rising edge” may generally refer to a leading edge of a pulse or square wave type of signal.

Here, “falling edge” may generally refer to a trailing edge of a pulse or square wave type of signal.

Here, “time delay” may generally refer to a delayed action, such as output of a control signal by a controller upon receipt of a sensor signal. In at least one example, a time delay may refer to a time interval between reception of a sensor signal and output of a control signal from controller.

Here, “optical detector” may generally refer to a detector that may be operable to receive light impinging on a light sensitive component of optical detector, such as a photodiode or a phototransistor. In at least one example, an optical detector may output a signal in response to absence or presence of light impinging on light sensitive component.

Here, “infrared light detector” may generally refer to an optical detector operable to detect infrared light.

Here, “light source” may generally refer to a device operational to output light. In at least one example, a light source may be a light emitting diode (LED). In at least one example, light source may provide a constant and calibrated light beam to an optical detector.

Here, “infrared light source” may generally refer to light source operable to emit infrared light.

Here, “movable partition” may generally refer to a door or partition that is movable by an actuator. In at least one example, a movable partition may pivot on a hinge, or may slide on a track.

Here, “metal detector” may generally refer to a device operable detect metallic objects. In at least one example, a metal detector may comprise an electromagnetic device, such as an inductor, that changes inductance if a ferrous object is within its magnetic field. In at least one example, a metal detector may also operate on a capacitive principle, where a change of capacitance may be caused by a nearby metal object.

Here, “tag implant” may generally refer to an object implanted in flesh of fish for identification and archiving purposes. In at least one example, a tag implant may contain identification information and other data related to fish. In at least one example, a tag implant may comprise any suitable metal, semiconductor (e.g., an RFID tag) or hybrid polymeric-metal or semimetal composite material. A tag implant may be detectable by a metal detector or by other means, such as RFID detection. In at least one example, a tag implant may be a coded wire tag (CWT) implanted within a snout portion of a fish. A CWT may contain printed information to identify individual tagged fish. The data on the CWT may include encoded data such as tagging date, tagging location, serial number, species and gender of the tagged fish. In at least one implementation, the tag implant may be embedded in cranial tissue of the fish.

Here, “coupled” and “connected,” along with their derivatives, can be used to describe functional or structural relationships between components. These terms are not intended as synonyms for each other. Rather, in particular implementations, the term “connected” can be used to indicate that two or more elements are in direct physical, optical, or electrical contact with each other. Here, “coupled” can be used to indicate that two or more elements are in either direct or indirect (with other intervening elements between them) physical, electrical or in magnetic contact with each other, and/or that two or more elements co-operate or interact with each other (e.g., as in a cause-and-effect relationship). Here, “coupled” can also generally refer to direct attachment of one electronic component to another. An electric or magnetic field can couple one component to another, where field may be controlled by one component to influence other in some manner.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one example, such variation is no more than +/−10% of referred value.

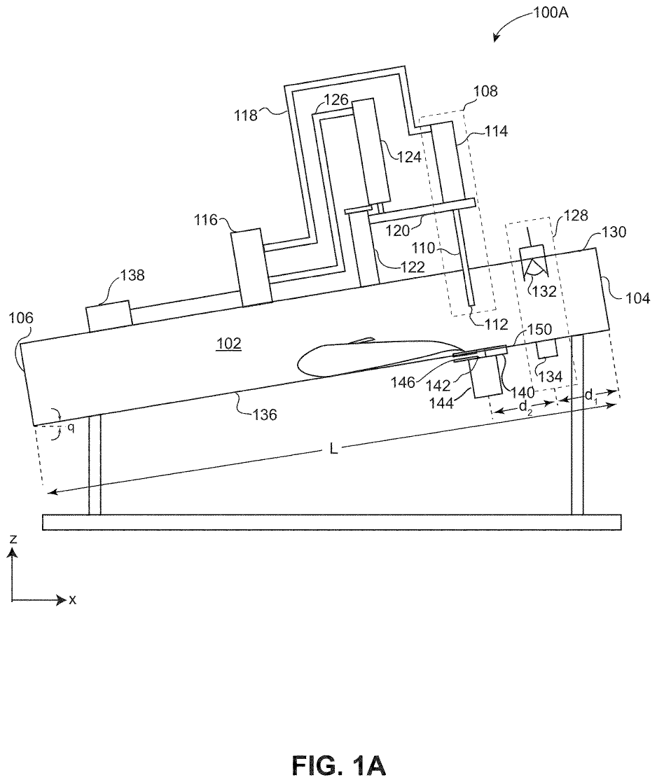

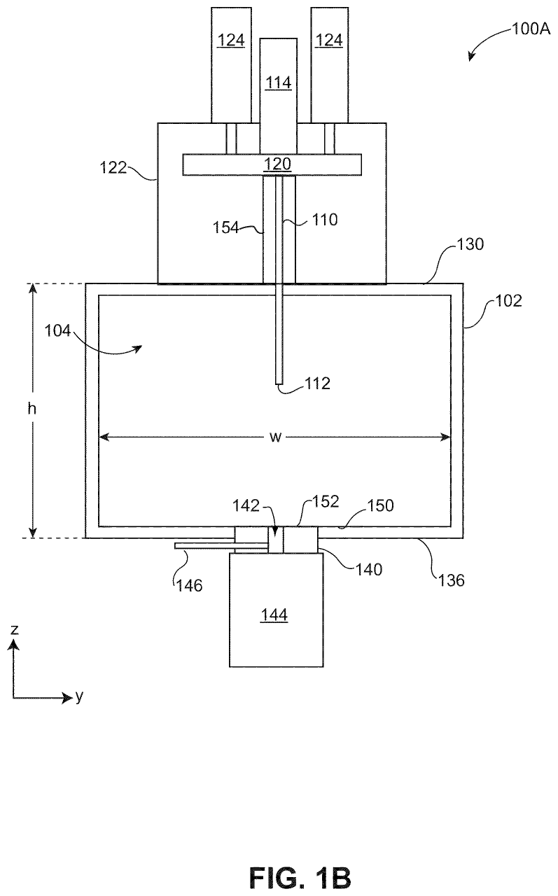

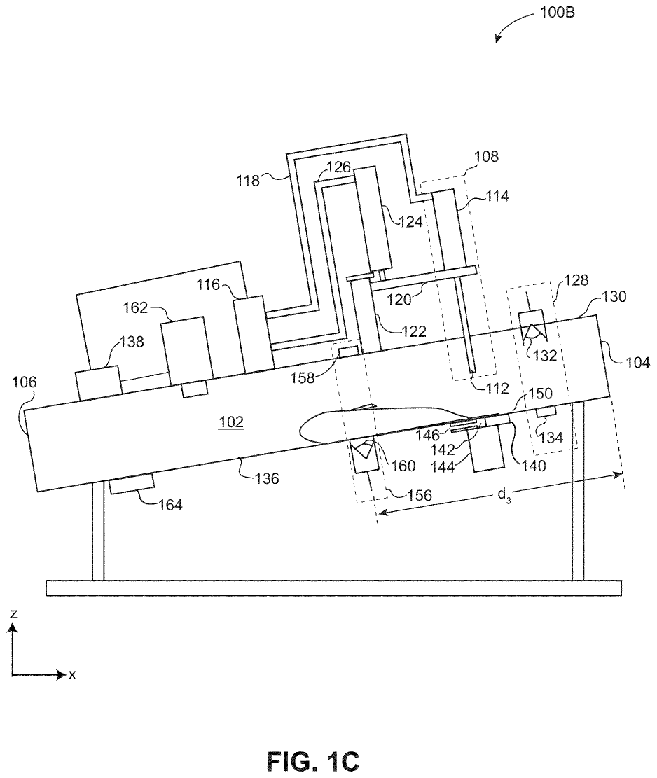

FIG. 1A illustrates a profile view of tissue sampling apparatus 100, in accordance with at least one example. In at least one example, tissue sampling apparatus 100 comprises tunnel 102. In at least one example, tunnel 102 has a hollow tubular body. In at least one example, tubular body of tunnel 102 has a round (e.g., circular or oval) cylindrical transverse cross section. In at least one example, tubular body of tunnel 102 has a rectilinear transverse cross section. In at least one example, the rectilinear cross section is rectangular. In at least one example, the rectilinear cross section is polygonal, having six sides or eight sides, for example. In at least one example, tunnel 102 comprises entrance opening 104 and exit opening 106. In at least one example, tunnel 102 has a length L that extends between entrance opening 104 and exit opening 106. In at least one example, length L may range between 1 and 2 meters.

In at least one example, tunnel 102 is tilted at an angle q. In at least one example, tilt angle q may be adjusted to enable gravity feeding of fish into tunnel 102. In at least one example, transit speed of fish (e.g., salmon) through tunnel 102 may in part be adjusted by adjustment of tilt angle q. In at least one example, q may range between 10 and 45 degrees.

In at least one example, punch 108 (enclosed in dashed outline) comprises shaft 110 and tip 112. In at least one example, punch 108 includes punch actuator 114. In at least one example, punch actuator 114 is a pneumatically activated piston drive, coupled to pneumatic valve block 116 by tubing 118. In at least one example, punch actuator 114 may be operable to rapidly drive shaft 110 downward in a stamping motion and return it to a home position immediately afterward.

In at least one example, punch actuator 114 is an electric (linear) motor drive. In at least one example, punch 108 is supported on stage 120. In at least one example, stage 120 is a movable stage that is coupled to support 122. In at least one example, stage 120 is operable to slide (e.g., vertically) along support 122. In at least one example, stage 120 is coupled to piston drive 124. In at least one example, piston drive 124 comprises a pneumatically driven piston mechanism, as shown. In at least one example, piston drive 124 is coupled to pneumatic valve block 116 may tubing 126.

In at least one example, piston drive 124 comprises an electrically driven piston mechanism. In at least one example, piston drive 124 may be immovably coupled to support 122. In at least one example, stage 120 may move downward to lower punch 108 into position for sampling tissue from a passing fish. In at least one example, piston drive may be triggered to lower stage 120 before shaft 110 of punch 108 is driven downward by punch actuator 114.

In at least one example motion sensor 128 or components of motion sensor 128 may be attached to and/or extending through wall 130 of tunnel 102, near entrance opening 104. In at least one example, motion sensor 128 may be entirely within tunnel 102. In at least one example, motion sensor 128 may comprise optical detector 132. In at least one example, motion sensor may comprise light source 134 to supply light for optical detector 132. In at least one example, light source 134 is an infrared light source.

In at least one example, light source 134 attached to and/or extending through wall 136 of tunnel 102. In at least one example, light source 134 is entirely inside tunnel 102. In at least one example, optical detector comprises an infrared detector, such as a photodiode or phototransistor. In at least one example, optical detector 132 comprises a video camera or a charge-capture device (CCD). In at least one example, motion sensor 128 comprises an acoustic motion sensor. In at least one example, motion sensor 128 may be positioned a distance d₁ from entrance opening 104. For example, d₁ may be 6 to 10 cm from entrance opening 104. In at least one example, motion sensor 128 may detect introduction of a fish fed into tunnel 102, and its motion. In at least one example, motion sensor 128 may generate a detection signal that activates punch 108 to move down to obtain a tissue sample from fish.

In at least one example, motion sensor 128 may be electrically coupled to controller 138. In at least one example, motion sensor 128 is physically attached to wall 130, as shown. In at least one example, motion sensor 128 may be remotely located with respect to tunnel 102. In at least one example, controller 138 may be operable to receive detection signals from motion sensor 128 and send control signals to pneumatic valve block 116. In at least one example, pneumatic valve block 116 may open and close pneumatic valves, for example, to send compressed air into tubing 118 and 126 to drive punch actuator 114 and piston drive 124.

In at least one example, anvil 140 is attached to wall 136. In at least one example, anvil 140 may be flush with inner surface 150 of wall 136. In at least one example, anvil 140 may provide a platform for punch 108, for example, supporting a tail fin of a fish that is to be sampled. In at least one example, sampling process may comprise driving tip 112 of punch 108 through a tail fin to cut a small portion of tail fin tissue. In at least one example, anvil 140 may support tail fin, allowing tip 112 to be driven cleanly through tail fin. In at least one example, anvil 140 comprises hole 142. In at least one example, the diameter of hole 142 is slightly larger than the diameter of shaft 110. In at least one example, tip 112 of punch 108 may penetrate hole 142, and into collection vessel 144. In at least one example, collection vessel 144 may be attached to wall 136 and located directly below anvil 140. In at least one example, anvil 140 comprises coupling 146 for attaching pneumatic tubing (not shown). In at least one example, coupling 146 may enable pulses of compressed air to be directed at tip 112 to remove a tissue sample from tip 112 by blowing, as tissue sample may adhere to tip 112 by surface tension, for example. In at least one example, tissue sample may fall into collection vessel 144.

FIG. 1B illustrates an end-on view of tissue sampling apparatus 100 in accordance with at least one example, looking into tunnel 102 through entrance opening 104. In at least one example, shaft 110 may be substantially centered within tunnel 102 with respect to width w. In at least one example, width w may range between approximately 30 cm and 100 cm. In at least one example, tunnel 102 has a height h that may range between approximately 30 and 50 cm. In at least one example, while cross section of tunnel 102 is shown to be rectangular, tunnel 102 may have a circular or polygonal cross section, as noted above.

In at least one example, anvil 140 is flush with inner surface 150 of wall 136. In at least one example, anvil 140 may be sunken below inner surface 150. In at least one example, anvil 140 may protrude slightly above inner surface 150. In at least one example, anvil 140 may comprise a leading edge 152 which is sloped or rounded to enable a fish to slide over it without encountering resistance if leading edge 152 protrudes above inner surface 150. In at least one example, inner surface 150 may be coated with a lubricant to facilitate transit of fish through tunnel 102.

In at least one example, hole 142 may be aligned to receive shaft 110. In at least one example, tip 112 and shaft 110 may be held at a home position, or rest height, within tunnel 102 to allow passage of a large fish prior to tissue sampling and after tissue sampling has been performed. In at least one example, rest height at which tip may be maintained may prevent tip 112 from reaching anvil 140. In at least one example, punch 108 may be mounted on stage 120. In at least one example, punch actuator 114 may be attached on stage 120. In at least one example, stage 120 may be coupled to track 154 in support 122. In at least one example, track 154 may be movable to enable stage 120 to be lowered to move punch 108 into sampling position, and elevated after a sampling sequence has been executed. In at least one example, stage 120 may be actuated by piston drives 124. In at least one example, piston drives 124 may be pneumatic pistons. In at least one example, piston drives 124 may be linear electric motor drives. In at least one example, track 154 may comprise a pully system or a caterpillar style track.

In at least one example, coupling 146 may extend from anvil 140 to receive pneumatic tubing (not shown). In at least one example, coupling 146 may be a threaded hole in anvil 140, to which tubing may be coupled. In at least one example, hole 142 extends from inner surface 150 to collection vessel 144. In at least one example, during operation, tip 112 may extend into hole 142 and into collection vessel 144 after passing through a fish's tail fin, for example. In at least one example, tip 112 may carry tissue sample while travelling downward. In at least one example, a pulse of compressed air may be released into hole 142 through coupling 146 during transit of tip 112, blowing tissue sample from tip (if adhering), enabling tissue sample to fall into collection vessel 144.

FIG. 1C illustrates a profile view of tissue sampling apparatus 100B, in accordance with at least one example. In at least one example, tissue sampling apparatus 100B comprises tunnel 102. In at least one example, tunnel 102 is substantially the same as shown in FIG. 1A and described above. In at least one example, tissue sampling apparatus 100B comprises an additional motion sensor 156. In at least one example, motion sensor 156 is located at a distance d₃ downstream from entrance opening 104.

In at least one example, motion sensor 128 is located at a distance d₁ from entrance opening 104, upstream from motion sensor 156. In at least one example, distance d₃ is larger than distance d₁+d₂. In at least one example, motion sensor 156 may be a redundant sensor employed to augment motion sensor 128. For example, motion sensor 156 may detect presence of a fish at distance d₃, confirming or correcting initial detection of the fish by motion sensor 128. For example, if a fish's mouth and/or gills are open, detection of the fish may be delayed as light from light source 134 may pass through the open mouth or gills mostly unimpeded. The delay may cause controller 138 to overestimate the length of the fish, triggering punch 108 too late, for example, after the tail fin has passed over anvil 140. In at least one example, motion sensor 156 may be employed to confirm detection by motion sensor 128, estimate its length and/or transit speed to estimate its mass (weight).

In at least one example, motion sensor 156 may comprise light source 158 and optical detector 160. In at least one example, light source 158 is an infrared light source. In at least one example, optical detector 160 is an infrared detector. In at least one example, optical detector 160 comprises a video camera or a CCD array. In at least one example, motion sensor 156 comprises an acoustic sensor.

In at least one example, tissue sampling apparatus 100B comprises video camera 162. In at least one example, video camera 162 may be attached to a wall of tunnel 102, such as wall 130. In at least one example, video camera 162 may record video images of fish as they transit through tunnel 102. Video images may be employed to document the physical characteristics and state of the individual fish.

In at least one example, tissue sampling apparatus 100B comprises metal detector 164. In at least one example, the metal detector may be employed to detect fish that have implanted metal tags within their flesh. In at least one example, metal detector 164 may be electrically coupled to controller 138. In at least one example, detection of implanted tags may trigger a partition near the exit of tunnel 102 to automatically sort fish having tag implants from fish that do not have such tags. This process is described below.

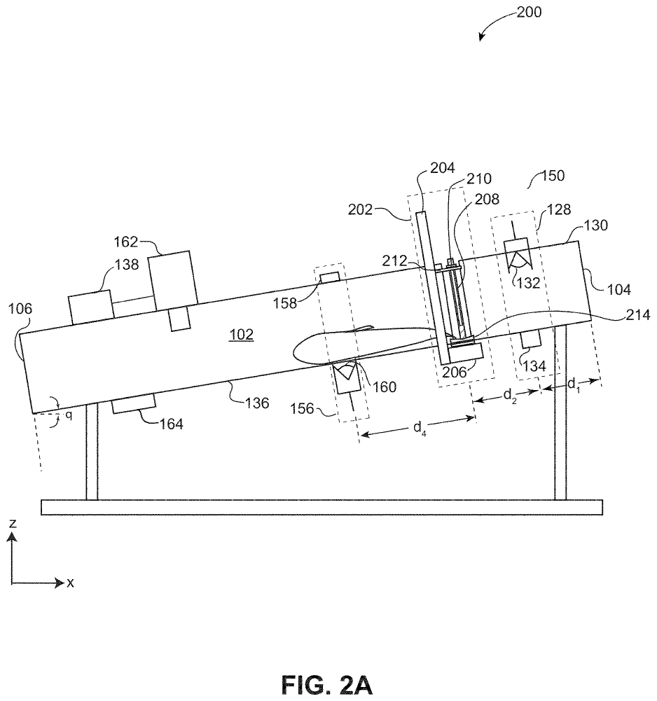

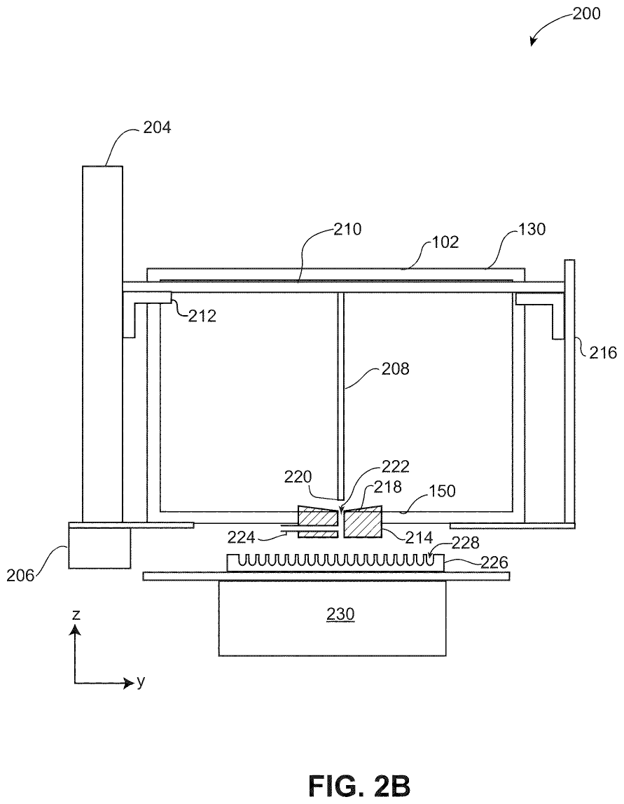

FIG. 2A illustrates a profile view of tissue sampling apparatus 200, in accordance with at least one example. In at least one example, tissue sampling apparatus 200 has many of the same features of sampling apparatuses 100A and 100B, with the exception of punch 108 and accompanying pneumatic drive system (e.g., comprising pneumatic valve block 116, piston drive 124, and punch actuator 114). In at least one example, tissue sampling apparatus 200 comprises punch 202, replacing a pneumatically driven punch (e.g., punch 108). In the figure, punch 202 comprises multiple components (described below) that are delineated within the dashed box.

In at least one example, punch 202 comprises linear drive actuator 204. In at least one example, linear drive actuator 204 is mechanically coupled to motor 206 and is driven thereby. In at least one example, shaft 208 of punch 202 is mechanically coupled to linear drive actuator 204 through yoke 210 and bracket 212, whereby yoke 210 is coupled to linear drive actuator 204 through bracket 212.

In at least one example, linear drive actuator 204 is belt driven. In at least one example, linear drive actuator 204 is screw driven. In at least one example, motor 206 is a stepper motor. In at least one example, motor 206 is a DC servomotor. In at least one example, linear drive actuator 204 has a more rapid response than a pneumatically driven drive mechanism.

In at least one example, shaft 208 is aligned with anvil 214. During operation, tissue samples may be taken from tail fins of fish passing through tissue sampling apparatus 200 by triggering linear drive actuator 204, driving shaft 208 downward to anvil 214. In at least one example, punch 202 is configured to be triggered when fish passes through motion sensor 156, between light source 158 and optical detector 160. In at least one example, motion sensor 156 is position a distance da from center of anvil 214. In at least one example, d₄ may be adjusted to approximate an average or accepted nose-to-tail length of fish typically sampled. For example, when the head of a fish passes through motion sensor 156, punch 202 is triggered as tail fin is positioned over anvil 214, extracting a piece of tail fin tissue.

In at least one example, motion sensor 156 and punch 202 are coupled to controller 138. In at least one example, controller 138 is configured to read signals from motion sensor 156 and send signals to linear drive actuator 204 to drive shaft 208 toward anvil 214. In at least one example, controller 138 is configured to time the trigger event to occur within an interval of several milliseconds to tens of milliseconds after initial detection of the head of a fish. For example, the rising or falling edge of the motion detector signal may be a marker signal from which a countdown starts, where the countdown determines a delay in the trigger signal transmission to punch 202.

In at least one example, tissue sampling apparatus 200 comprises video camera 162. In at least one example, video camera 162 may be attached to a wall of tunnel 102, such as wall 130. In at least one example, video camera 162 may record video images of fish as they transit through tunnel 102. Video images may be employed to document the physical characteristics and state of the individual fish.

FIG. 2B illustrates an end-on view of tissue sampling apparatus 200, in accordance with at least one example. In at least one example, yoke 210 is attached to a track (not shown) in support 216. In at least one example, support 216 is affixed to tunnel 102. In at least one example, support 216 provides mechanical support for yoke 210, enabling yoke 210 to slide up and down support 216 by engagement of the track with yoke 210.

In at least one example, anvil 214 comprises sloped surface 218 protruding above inner surface 150 of tunnel 102, enabling guiding or centering of tip 220 of shaft 208 within through-hole 222 in anvil 214. In at least one example, sloped surface 218 is conical. In at least one example, sloped surface 218 is wedge-shaped. In at least one example, tip 220 of shaft 208 comprises cutting edges to cut away (e.g., “snip” or “punch”) a sample of fin tissue from fish passing through tissue sampling apparatus 200. In at least one example, anvil 214 comprises conduit 224. In at least one example, conduit 224 is configured to introduce pressurized air or water to push the tissue sample out of through-hole 222 into a catchment 226 positioned below (or adjacent to for horizontal configurations). In at least one example, an example of catchment 226 may comprise a multi-well plate, as shown in the figure. In at least one example, catchment 226 may comprise a train of discrete sample tubes. In at least one example, wells 228 within the multi-well plate may capture tissue samples that fall from through-hole 222. In at least one example, wells 228 may be successively positioned underneath through-hole 222 by x-y table 230. In at least one example, wells 228 may contain a liquid preservative such as ethanol or formaldehyde to preserve tissue samples.

In at least one example, catchment 226 may comprise a paper or polymer dry-storage card, whereby tissue samples are made to adhere to the dry-storage card and are preserved without a liquid preservative such as ethanol. In at least one example, the dry-storage card may be positioned on an x-y table, such as x-y table 230 shown positioned under the multi-well plate example of catchment 226. A single card may be any suitable dimension to capture a large number of tissue samples. The method of capture may be similar to that used for a multi-well plate.

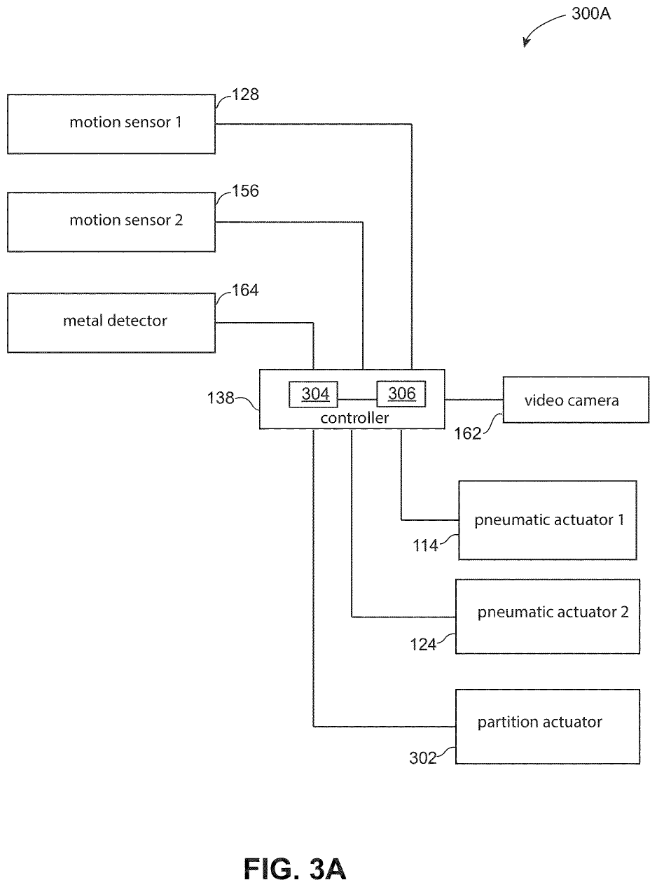

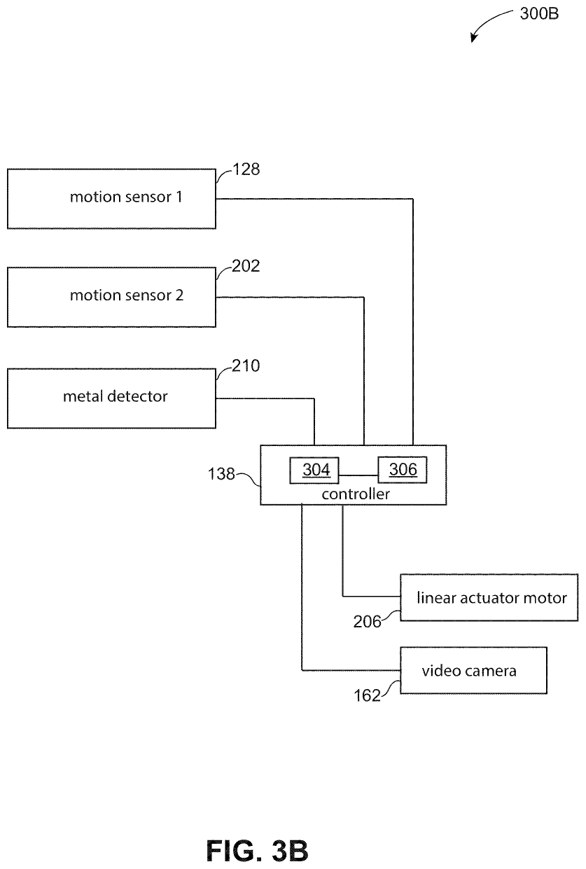

FIG. 3A illustrates a block diagram of control system 300A for tissue sampling apparatus 100, in accordance with at least one example. In at least one example, control system 300A comprises controller 138. In at least one example, controller 138 may be electrically coupled to motion sensor 128. In at least one example, controller 138 may also be electrically coupled to motion sensor 156. In at least one example, controller 138 may also be electrically coupled to metal detector 164.

In at least one example, controller 138 may be electrically coupled to punch actuator 114. In at least one example, controller 138 may be electrically coupled to piston drive(s) 124. In at least one example, controller 138 may be electrically coupled to partition actuator 302.

In at least one example, controller 138 may comprise a processor 304 and memory 306 coupled to processor 304. In at least one example, processor 304 may be a single chip microprocessor. In at least one example, processor 304 may be a single board computer. In at least one example, processor 304 may be a general-purpose computer. In at least one example, memory 306 may store binary code to process sensor input signals received from motion sensors 128 and 156, and metal detector 164. In at least one example sensor signals may be digital or analog voltages or currents. In at least one example, binary code stored in memory 306 may be operable to command processor 304 to output control signals coupled based on sensor input. In at least one example, control signals may be digital or analog voltage signals. In at least one example, processor 304 may be coupled to digital-to-analog converters that are coupled to power amplifiers (e.g., a transistor) to drive pneumatic valves, for example, in pneumatic valve block 116, to punch actuator 114 and piston drive(s) 124.

In at least one example, an output voltage from motion sensor 128 may be monitored by processor 304. In at least one example, when voltage changes to a threshold level, indicating blockage of light from light source 134 reaching optical detector 132, for example, binary code stored in memory 306 may instruct processor 304 to output a control signal to trigger piston drive(s) 124 and punch actuator 114.

In at least one example, binary code may instruct processor 304 to issue control signal after a predetermined time delay. In at least one example, time delay may be related to a distance fish may traverse after an initial detection event. In at least one example, time delay may permit fish to travel approximately its length to trigger punch 108 when its tail fin is over anvil 140. In at least one example, time delay may be adjusted for fish size and estimated transit speed.

In at least one example, controller 138 is coupled to video camera 162. In at least one example, processor 304 within controller 138 is operational to execute machine vision software and machine learning software that may be stored in memory 306 to capture images of fish during transit. In at least one example, processor 304 is operational to execute software for identification of fish species and gender. In at least one example, processor 304 is operational to execute machine vision software capable of estimating the size and weight of each fish recorded, as well providing a determination of overall health and physical condition. In at least one example, machine learning software may be trained in advance of placement of a tissue sampling apparatus (e.g., tissue sampling apparatus 100) in service for tissue sampling operations to recognize fish species, gender, and other attributes, enabling artificial intelligence-based algorithms to conduct image analysis during tissue sampling operations.

FIG. 3B illustrates a block diagram of control system 300B for tissue sampling apparatus 200, in accordance with at least one example. In at least one example, controller 138 is coupled to motor 206 of punch 202. In at least one example, motor 206 is linear actuator motor. In at least one example, motor 206 is a linear drive motor. In at least one example, processor 304 of controller 138 is coupled to an internal or external motor drive circuit to operate motor 206. In at least one example, motor 206 may be triggered to operate in a similar manner as described for the pneumatic system (e.g., punch actuator 114) described above.

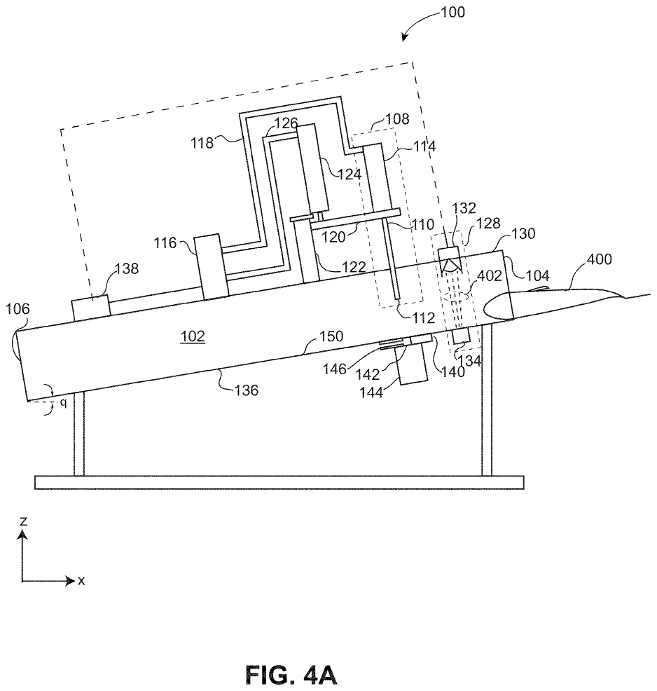

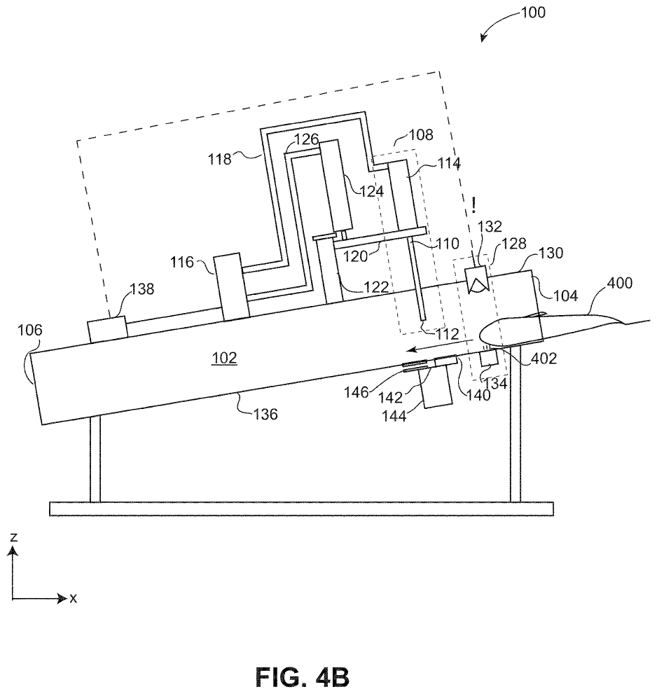

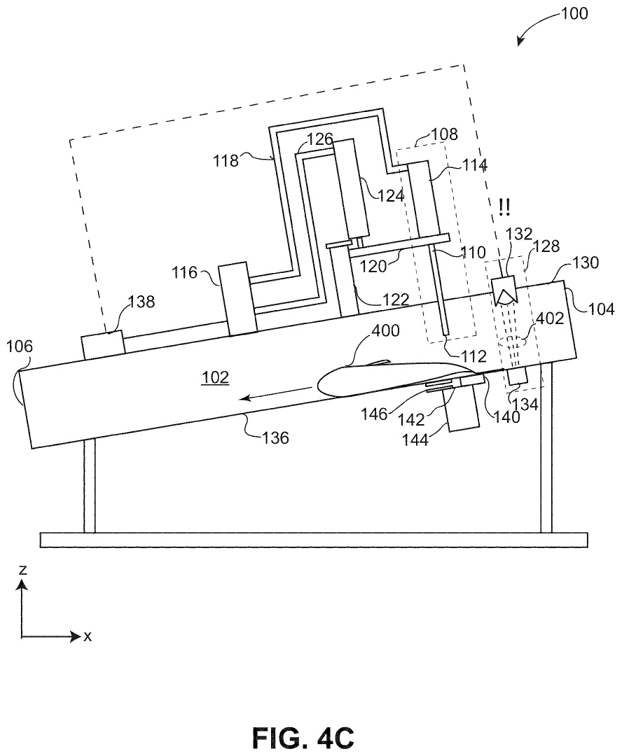

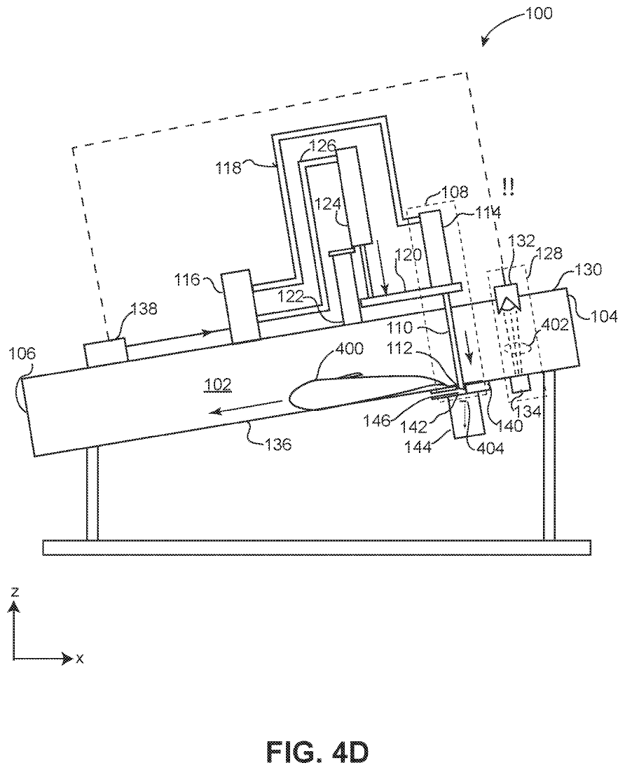

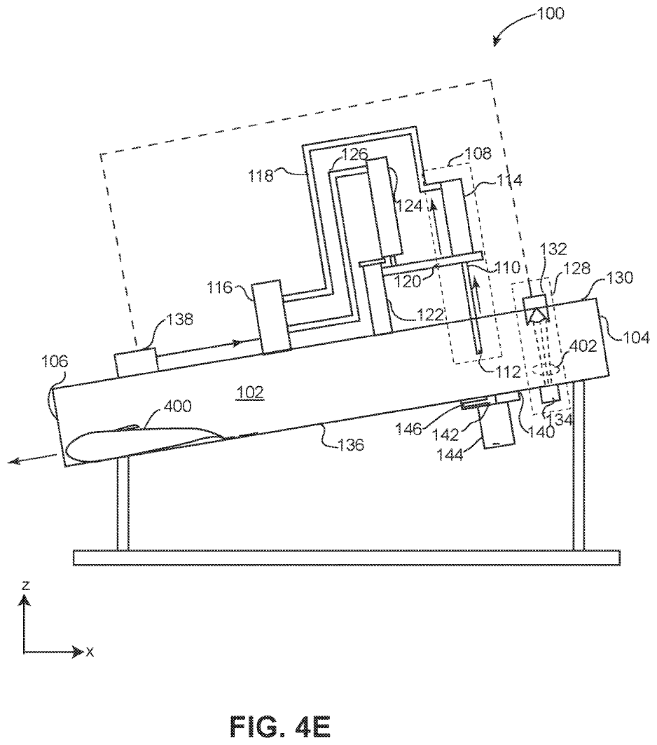

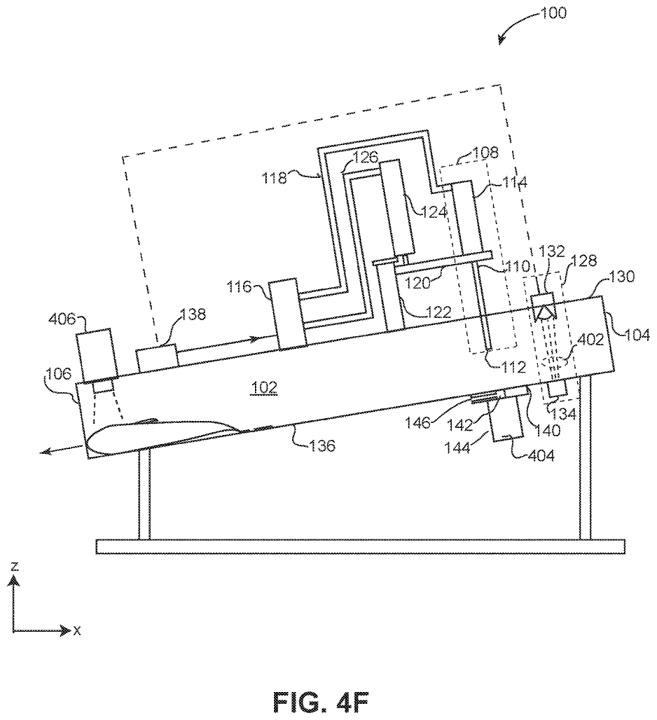

FIGS. 4A-4F illustrate a sequence of exemplary method steps for operation of a tissue sampling apparatus, such as tissue sampling apparatus 100, according to at least one example. Referring to FIG. 4A, fish 400 (e.g., salmon) is fed into entrance opening 104 of tunnel 102. In at least one example, fish 400 may be manually fed by a hatchery employee or operator, for example, into tunnel 102. In at least one example, fish 400 may be fed by a conveyer belt. In at least one example, fish 400 may begin to slide on inner surface 150 of wall 136 under influence of gravity. In at least one example, amount of gravitational acceleration may be adjusted by adjustment of tilt angle θ. In at least one example, inner surface 150 may be coated with a lubricant to enable sliding of fish 400. In at least one example, motion sensor 128 is in active sensing mode as indicated by light beam 402.

In FIG. 4B, fish 400 has moved a distance down tunnel 102, passing over light source 134. In at least one example, fish 400 begins to block light beam 402. In at least one example, optical detector 132 generates a signal, denoted by exclamation point (!) above optical detector 132. In at least one example, controller 138 receives signal (dashed lines indicate electronic coupling between optical detector 132 and controller 138. In at least one example, controller 138 may immediately issue a control signal to piston drive(s) 124 and punch actuator 114 to actuate punch 108 and stage 120. In at least one example, controller 138 may issue a control signal to piston drive(s) 124 and punch actuator 114 after a time delay. In at least one example, time delay may permit fish 400 to transit a distance approximately equal to its length so that tail fin may overlap anvil 140 before punch 108 is triggered to cut a tissue sample.

In FIG. 4C, an alternative triggering mechanism is shown. In at least one example, fish 400 advances down tunnel 102 and passes through motion sensor 128. In at least one example, as tail fin passes through motion sensor 128, a signal output may be generated by optical detector 132 indicating that body of fish 400 has completely passed through motion sensor 128. In at least one example, as tail fin moves through motion sensor 128, light beam 402 is restored. In at least one example, output signal, indicated by a double exclamation point (!!) above optical detector 132, may be received by controller 138 as an analog signal output from optical detector 132, such as a rising or falling edge. In at least one example, controller 138 may receive a detection signal generated by motion sensor 128. In at least one example, the output signal may cause controller 138 to trigger punch 108.

In FIG. 4D, the tail fin of fish 400 is over anvil 140. In at least one example, punch 108 is actuated by controller 138. In at least one example, controller 138 may send a control signal to actuators on pneumatic valve block 116. In at least one example, pneumatic valves on pneumatic valve block 116 are opened, sending compressed air to punch actuator 114 and piston driver(s) 124 through tubing 118 and 126. In at least one example, punch actuator 114 and piston driver(s) 124 may be electric motor drives. In at least one example, stage 120 is driven downward by piston driver(s) 124, as indicated by the down arrow. In at least one example, tip 112 is driven through tail fin in a rapid stamping motion by punch actuator 114.

In at least one example, tip 112 enters hole 142 through anvil 140 carrying tissue sample 404. In at least one example, tip 112 may move into collection vessel 144. In at least one example, compressed air is fed into hole 142 through coupling 146. In at least one example, compressed air may force tissue sample 404 off tip 112 if tissue sample 404 adheres to tip 112 by surface tension. In at least one example, tissue sample 404 may fall into collection vessel 144.

In FIG. 4E, fish 400 exits tunnel 102 through exit opening 106. In at least one example, stage 120 and punch 108 are restored to a home position, as indicated by upward pointing arrows.

In FIG. 4F, in at least one example, video camera 406 may be included near exit opening 106 or at another suitable position along tunnel 102. In at least one example, video camera 406 may record images of fish 400. Images may be assessed in real time or later to analyze the size, gender, and condition of fish 400.

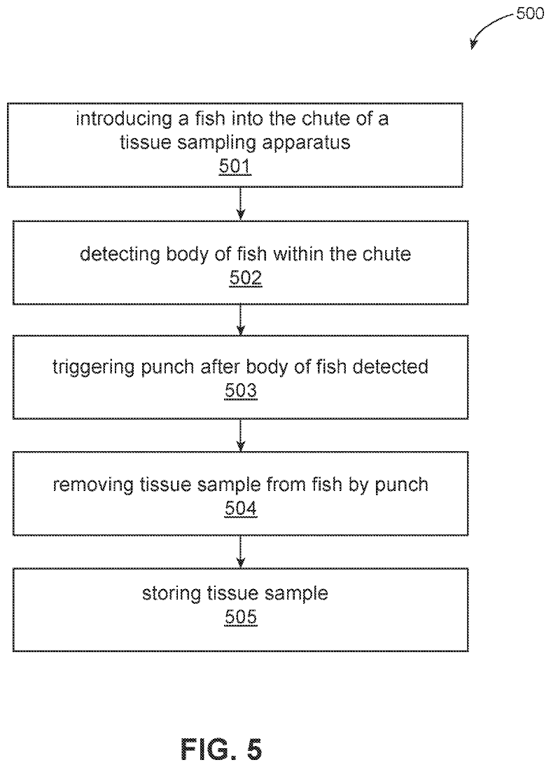

FIG. 5 presents a flowchart 500 recapping method illustrated in FIGS. 4A-4F, in accordance with at least one example. Here, references may be made to specific features and components of tissue sampling apparatus 100 shown in FIG. 1A.

At operation 501, in accordance with at least one example, fish (e.g., fish 400, FIGS. 4A-4F), such as a salmon, are introduced by gravity feeding into entrance opening (e.g., entrance opening 104, FIG. 1A) of tunnel 102 of tissue sampling apparatus 100. In at least one example, fish may be gravity fed into tunnel manually. In at least one example, fish may be fed automatically, for example by a conveyer belt. In at least one example, fish slides down tunnel 102, tilted at an angle (e.g., angle θ) at approximately a predetermined speed as determined by gravity and angle θ. In at least one example, angle q may be adjusted to regulate transit speed of fish. In at least one example, inner surface 150 of wall 136 of tunnel 102 may be coated with a lubricant to facilitate transit of fish through tunnel 102.

At operation 502, a motion sensor (e.g., motion sensor 128) located near entrance of tunnel 102 detects body of fish moving through or near motion sensor 128. In at least one example, motion sensor 128 may detect movement of the head (or tail) of fish. In at least one example, an optical path of light may be blocked as fishes pass through the light path, whereby motion sensor 128 generates a signal that is received by controller 138. In at least one example, the signal may be falling or rising edge of an analog sensor output voltage monitored by controller 138. In at least one example, the signal may be a digital output voltage monitored by controller 138.

In at least one example, at operation 503, a punch mechanism (e.g., punch 108) is triggered to plunge tip of punch 108 (e.g., tip 112) through a portion of fish, such as tail fin. In at least one example, tip 112 cuts through tail fin and removes a tissue sample from tail fin. In at least one example, punch 108 may be triggered by controller 138 after controller 138 receives detection signal from motion sensor 128. In at least one example, the trigger signal may be output from controller 138 after a time delay. In at least one example, time delay may be a preset value, measured from time of initial detection of a leading portion of fish by motion sensor 128. In at least one example, controller 138 may issue trigger signal after fish completely passes by or through motion sensor 128. In at least one example, controller 138 is operable to trigger punch 108 when tail fin is positioned over anvil 140.

In at least one example, at operation 504, tip 112 cuts through a portion of fish. In at least one example, tip 112 cuts through the tail fin of fish. In at least one example, tail fin of fish is supported on anvil 140 so that tip 112 may cleanly penetrate tail fin (or other suitable part of fish), removing a small sample of tissue. In at least one example, tip 112 travels through hole 142 in anvil 140. In at least one example, compressed air is introduced into hole 142, for example, through coupling 146. In at least one example, compressed air may force tissue sample from tip 112, as tissue adhere to tip 112 by surface tension.

In at least one example, at operation 505, tissue sample may fall through hole 142 into a collection vessel below hole 142, such as collection vessel 144. In at least one example, tissue sample may be aggregated with multiple tissue samples collected in collection vessel 144. In at least one example, aggregated tissue samples stored in collection vessel 144 may be analyzed later.

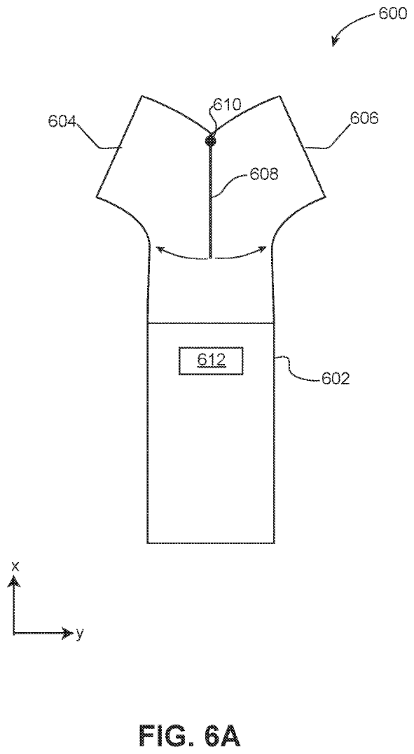

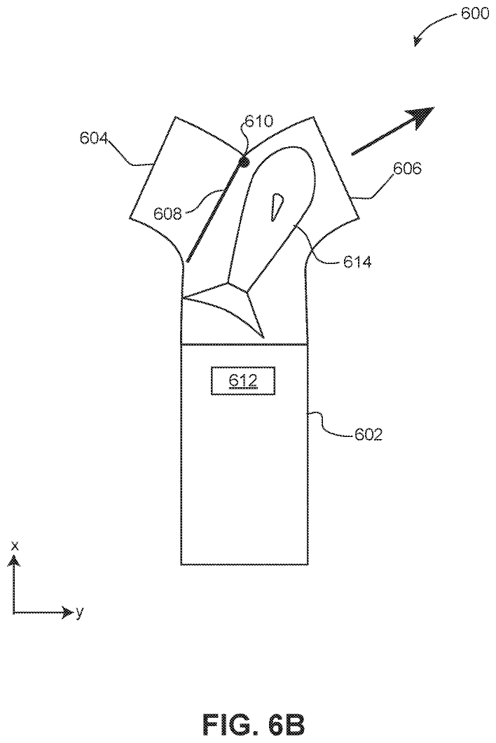

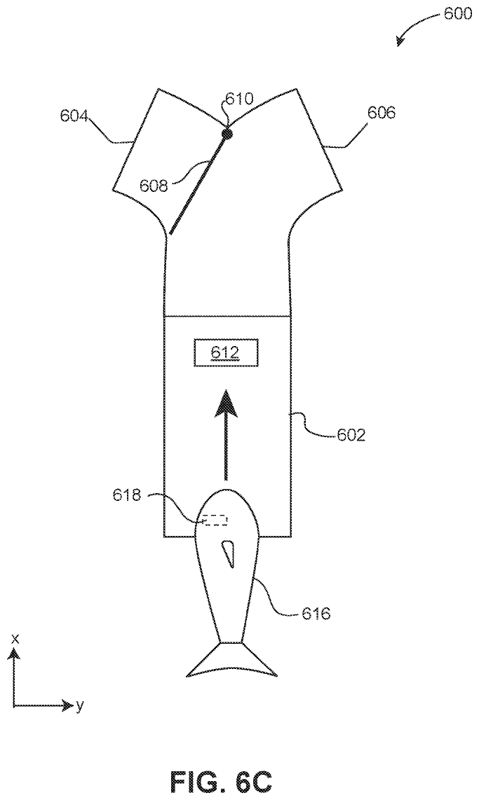

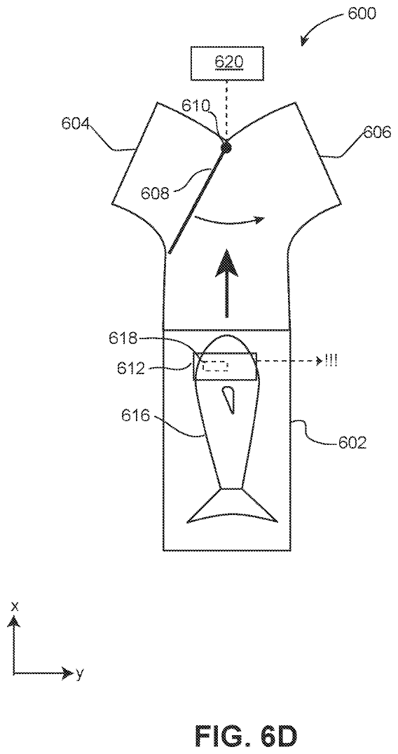

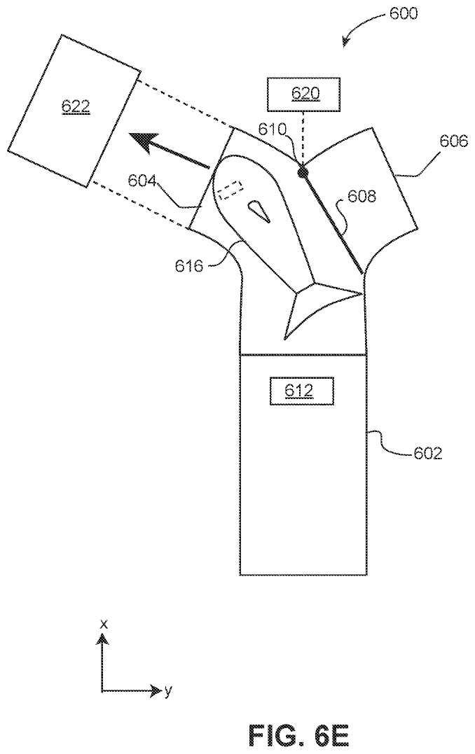

FIGS. 6A-6E illustrate a sequence of operations of a method of operation of tissue sampling apparatus 600, in accordance with at least one example.

FIG. 6A illustrates a plan view of tissue sampling apparatus 600, in accordance with at least one example. In at least one example, exit portion of tunnel 602 of tissue sampling apparatus 600 is shown. In at least one example, tunnel 602 comprises a bifurcated exit opening, comprising exit opening 604 adjacent to exit opening 606. In at least one example, exit openings 604 and 606 present two exit paths for sorting fish having metal tag implants from untagged fish. In at least one example, expensive implanted tags may be recuperated by separating and collecting tagged fish.

In at least one example, tunnel 602 comprises partition 608. In at least one example, partition 608 is operable to swivel from hinge 610. In at least one example, partition 608 is operable to pivot between exit openings 604 and 606, as indicated by curved arrows. In at least one example, partition 608 may be actuated by controller 138 (see FIGS. 3A-B) based on input from metal detector 612. In at least one example, metal detector 612 is mounted along tunnel 602, in path of fish transiting through tunnel 602. In at least one example, metal detector 612 may detect presence of metal tag implants in some fish that are processed in tissue sampling apparatus 600. For example, between 2% and 5% of fish processed in tissue sampling apparatus 600 have tag implants.

FIGS. 6B-6E illustrate a series of plan views of an operation of tissue sampling apparatus 600, in accordance with at least one example. Referring to FIG. 6B, in at least one example, fish 614 has transited through tunnel 602, having passed metal detector 612. In at least one example, fish 614 is an untagged fish, lacking a metal implant. In at least one example, metal detector 612 does not detect presence of metal within body of fish 614 and does not present a detection signal to controller 138. In at least one example, partition 608 is positioned to block exit opening 604, directing fish 614 to exit opening 606. In at least one example, fish 614 is forced to leave tunnel 602 through exit opening 606.

In FIG. 6C, in accordance with at least one example, fish 616 is in transit through tunnel 602, following fish 614. In at least one example, fish 616 is shown prior to passage over metal detector 612. In at least one example, fish 616 is a tagged fish, possessing tag implant618.

In FIG. 6D, fish 616 passes over metal detector 612. In at least one example, metal detector 612 detects tag implant618 within fish 616 and outputs a detection signal, indicated by triple exclamation point (!!!) to controller 138 (see FIGS. 3A-B). In at least one example, controller 138 issues a control signal to partition actuator 620. In at least one example, marker signal is marker signal. In at least one example, marker signal is an analog signal. In at least one example, marker signal is a digital signal. In at least one example, partition actuator 620 is mechanically coupled to hinge 610. In at least one example, partition actuator 620 drives hinge 610 to pivot partition 608 toward exit opening 606.

In FIG. 6E, partition 608 is pivoted to exit opening 606. In at least one example, partition 608 blocks exit opening 606. In at least one example, fish 616 is directed toward exit opening 604. In at least one example, fish 616 is forced to leave tunnel 602 through exit opening 604. In at least one example, fish 616 is directed to an operation to extract tag implant 618, indicated by the addition of tag extraction station 622 after exit opening 604. In at least one example, tag implant 618 is a coded wire tag (CWT). In at least one example, fish 616 is directed to tag extraction station 622 for extraction of tag implant 618 (e.g., a CWT). In at least one example, tag implant 618 may generally be embedded within the snout portion of fish 616. In at least one example, tag extraction station 622 may comprise a punch mechanism for removing cranial tissue from the snout of fish 616 that may contain the CWT tag implant. In at least one example, tag extraction station 622 is located upstream of exit opening 604 within tunnel 602.

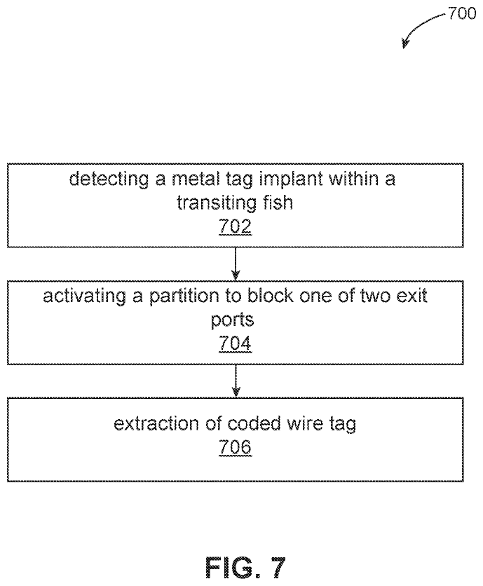

FIG. 7 illustrates a flowchart 700, recapping method illustrated in FIGS. 6A-6E, in accordance with at least one example. Here, references are made to features shown in FIGS. 6A-6E, as well as FIGS. 3A-B.

At operation 702, in at least one example, a fish possessing a tag implant (e.g., fish 616 possessing tag implant 618) transits through tunnel 602 of tissue sampling apparatus 600. In at least one example, metal detector 612 detects the presence of tag implant618 within body of fish 616. In at least one example, metal detector 612 outputs a detection signal that is received by controller 138. Partition 608 is initially positioned at a first exit opening (e.g., exit opening 604) of tunnel 602.

At operation 704, in at least one example, controller 138 outputs a control signal to partition actuator 620. In at least one example, partition actuator pivots partition 608 toward second exit opening (e.g., exit opening 606). In at least one example, partition 608 blocks the second exit opening, directing fish 616 to leave tunnel 602 through first exit opening (e.g., exit opening 604).

At operation 706, in at least one example, the fish is directed to a tag extraction station, such as tag extraction station 622. In at least one example, tag extraction station 622 may further comprise an apparatus for isolating tag implant 618 from surrounding tissue. For example, a combination of tissue extraction and guidance systems may be employed to remove all tissue around the CWT until the final CWT and immediate tissue can be isolated. An isolated CWT can be categorized and stored into individual isolated samples with other biological and physical data (e.g., date, location, species, sex, length, weight, condition). System integration and coding can associate this CWT sample with all the other data taken for each sample.

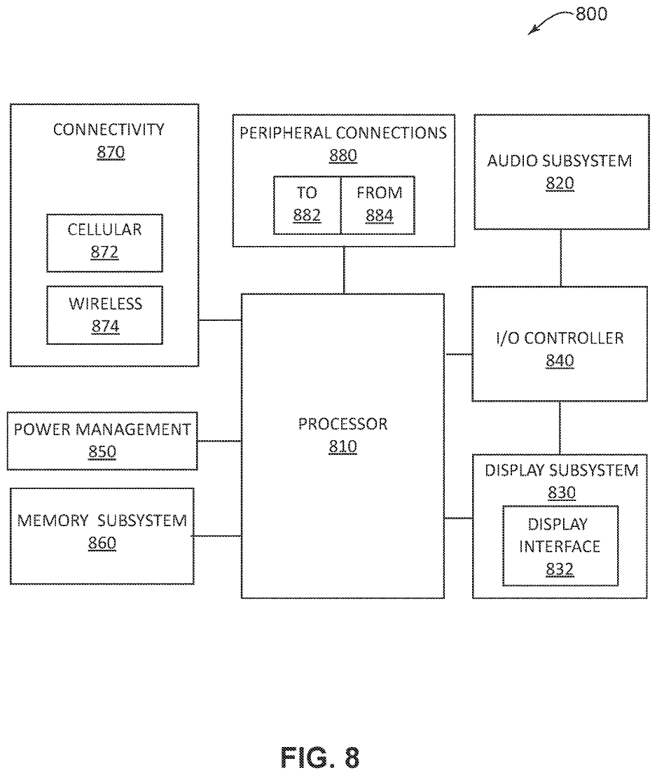

FIG. 8 illustrates a computing device 800 (also referred to as a computer system), in accordance with some implementations. In at least one example, computing device 800 represents an appropriate computing device, such as a computing tablet, a mobile phone or smart-phone, a laptop, a desktop, an Internet-of-Things (IOT) device, a server, a set-top box, a wireless-enabled e-reader, or the like. It will be understood that certain components are shown generally, and not all components of such a device are shown in computing device 800.

In at least one example, computing device 800 includes processor 810, which may be processor 304 embedded within controller 138, for example. The various examples may also comprise a network interface within connectivity block 870 such as a wireless interface so that a system implementation may be incorporated into a wireless device, for example, cell phone or personal digital assistant.

In at least one example, processor 810 can be an integrated circuit which can include one or more physical devices, such as microprocessors, application processors, microcontrollers, programmable logic devices, or other processing means. In at least one example, the processing operations performed by processor 810 include the execution of an operating platform or operating system on which applications and/or device functions are executed. In at least one example, the processing operations include operations related to I/O (input/output) with a human user or with other devices, operations related to power management, and/or operations related to connecting the computing device 800 to another device. The processing operations may also include operations related to audio I/O and/or display I/O.

In at least one example, computing device 800 includes audio subsystem 820, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 800 or connected to the computing device 800. In at least one example, a user interacts with computing device 800 by providing audio commands that are received and processed by processor 810.

In at least one example, display subsystem 830 represents hardware (e.g., display devices) and software (e.g., drivers) components that provide a visual and/or tactile display for a user to interact with the computing device 800. In at least one example, display subsystem 830 includes display interface 832, which includes the particular screen, such as an LCD display, or remote hardware device used to provide a display to a user. In at least one example, display interface 832 includes logic separate from processor 810 to perform at least some processing related to the display. In at least one example, display subsystem 830 includes a touch screen (or touch pad) device that provides both output and input to a user.

In at least one example, I/O controller 840 represents hardware devices and software components related to interaction with serial or parallel communication interfaces of peripheral devices, whereby serial and parallel I/O interfaces may employ protocols such as USB, RS-232, RS 422, SPI, I2C, GPIB, CAN bus, Profibus, etc. In at least one example, I/O controller 840 may also be operable to manage hardware that is part of audio subsystem 820 and/or display subsystem 830. In at least one example, I/O controller 840 illustrates a connection point for additional devices that connect to computing device 800 through which a user might interact with the system. In at least one example, other peripheral devices that may be coupled to I/O controller 840 can include microphone devices, speaker or stereo systems for audio data to/from user, video systems or other display devices for visual data output, keyboard or keypad devices for user input, or other I/O devices for use with specific applications such as card readers or other devices.

As mentioned above, I/O controller 840 can interact with audio subsystem 820 and/or display subsystem 830. For example, input through a microphone or other audio device can provide input or commands for one or more applications or functions of the computing device 800. Additionally, audio output can be provided instead of, or in addition to, display output. In at least one example, if display subsystem 830 includes a touch screen, the display device also acts as an input device, which can be at least partially managed by I/O controller 840. In at least one example, there can also be additional buttons or switches on the computing device 800 to provide I/O functions managed by I/O controller 840.

In at least one example, I/O controller 840 manages devices such as punch 108 or punch 202 (See FIGS. 1A and 2A). In at least one implementation, I/O controller 840 manages cameras, such as video camera 162, light sensors or other environmental sensors, or other hardware that can be included in the computing device 800. In at least one example, the input can be part of direct user interaction, as well as providing environmental input to the system to influence its operations (such as filtering for noise, adjusting displays for brightness detection, applying a flash for a camera, or other features).

In at least one example, computing device 800 includes power management 850 that manages battery power usage, charging of the battery, and features related to power saving operation. In at least one example, memory subsystem 860 includes memory devices for storing information in computing device 800. In at least one example, memory can include nonvolatile (state does not change if power to the memory device is interrupted) and/or volatile (state is indeterminate if power to the memory device is interrupted) memory devices. In at least one example, memory subsystem 860 can store application data, user data, music, photos, documents, or other data, as well as system data (whether long-term or temporary) related to the execution of the applications and functions of the computing device 800.

In at least one example, elements of implementations are also provided as a machine-readable storage medium (e.g., memory subsystem 860) for storing the computer-executable instructions. In at least one example, memory subsystem 860 may include memory 306 as shown in FIG. 3A. In at least one example, memory subsystem 860 may store instructions to implement sampling operations, such as described in flowchart 700, and in the operations sequence shown by FIGS. 6A-6E. In at least one example, memory subsystem 860 may store machine-readable instructions to execute time-derivative algorithms for clean cycle endpoint determination. In at least one example, memory subsystem 860 may include instructions and data, for example in the form of look-up tables, for data collection for fish species and gender determinations. In at least one example, the machine-readable storage medium (e.g., memory subsystem 860) may include, but is not limited to, flash memory, optical disks, CD-ROMs, DVD ROMs, RAMs, EPROMs, EEPROMs, magnetic or optical cards, phase change memory (PCM), or other types of machine-readable storage media suitable for storing electronic or computer-executable instructions. In at least one example, implementations of the disclosure may be downloaded as a computer program (e.g., BIOS) which may be transferred from a remote computer (e.g., a server) to a requesting computer (e.g., a client) by way of data signals via a communication link (e.g., a modem or network connection).

In at least one example, connectivity block 870 includes hardware devices (e.g., wireless and/or wired connectors and communication hardware) and software components (e.g., drivers, protocol stacks) to enable the computing device 800 to communicate with external devices. In at least one example, computing device 800 could be separate devices, such as other computing devices, wireless access points or base stations, as well as peripherals such as headsets, printers, or other devices.

In at least one example, connectivity block 870 can include multiple different types of connectivity. To generalize, the computing device 800 is illustrated with cellular connectivity 872 and wireless connectivity 874. In at least one example, cellular connectivity 872 refers generally to cellular network connectivity provided by wireless carriers, such as provided via LTE (long term evolution), LTE 4G, LTE 5G, GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 874 refers to wireless connectivity that is not cellular, and can include personal area networks (such as Bluetooth, Near Field, etc.), local area networks (such as Wi-Fi), and/or wide area networks (such as LTE), or other wireless communication.

In at least one example, peripheral connections 880 include hardware interfaces and connectors, such as those peripherals enumerated above that are included with tissue sampling apparatus 100 or 200, as well as software components (e.g., drivers, protocol stacks) to make peripheral connections. It will be understood that the computing device 800 could both be a peripheral device (“to” 882) to other computing devices, as well as have peripheral devices (“from” 884) connected to it. In at least one example, computing device 800 commonly has a “docking” connector to connect to other computing devices for purposes such as managing (e.g., downloading and/or uploading, changing, synchronizing) content on computing device 800. In at least one example, a docking connector can allow computing device 800 to connect to certain peripherals that allow the computing device 800 to control content output to audiovisual or other systems.

In addition to a proprietary docking connector or other proprietary connection hardware, the computing device 800 can make peripheral connections 880 via common or standards-based connectors. In at least one example, common types can include a Universal Serial Bus (USB) connector (which can include any of a number of different hardware interfaces), DisplayPort including MiniDisplayPort (MDP), High-Definition Multimedia Interface (HDMI), Firewire, USB Type-C, or other types such as the protocols enumerated above.

In the following paragraphs, examples are provided that illustrate various implementations. Here, examples can be combined with other examples. As such, various implementations can be combined with other implementations without changing scope of disclosure.

Example 1 is an apparatus comprising a tunnel having a length extending between a first opening and a second opening; a motion sensor positioned on or within the tunnel at a first distance from the first opening, wherein the motion sensor is coupled to a controller; a punch comprising a shaft, wherein the shaft comprises a tip at an end of the shaft, and extends transversely into an interior region of the tunnel through an upper wall of the tunnel at a second distance from the first opening, wherein the second distance is larger than the first distance, and wherein the punch is coupled to an actuator, and wherein the actuator is coupled to the upper wall of the tunnel; and an anvil coupled to a lower wall of the tunnel below the tip of the shaft, wherein the anvil comprises a third opening extending through the lower wall of the tunnel and aligned to an axis of the punch, wherein the lower wall is opposite to the upper wall, and wherein a tissue catchment is below the third opening.

Example 2 is an apparatus according to any example herein, in particular example, 1, wherein a controller is electrically coupled to the motion sensor and to the actuator, wherein the controller is operable to receive a first signal from the motion sensor and send a second signal to the actuator upon reception of the first signal.

Example 3 is an apparatus according to any example herein, in particular example 2, wherein the actuator is a first pneumatic actuator attached to a movable stage, wherein the movable stage is coupled to the upper wall of the tunnel, and wherein the movable stage is coupled to a second pneumatic actuator coupled to the upper wall of the tunnel.

Example 4 is an apparatus according to any example herein, in particular example 3, wherein the controller is operable to send the second signal simultaneously to the first pneumatic actuator and to the second pneumatic actuator after a time delay.

Example 5 is an apparatus according to any example herein, in particular example 2, wherein the actuator is a linear actuator, wherein the controller is operable to send the second signal to a motor drive coupled to the linear actuator.

Example 6 is an apparatus according to any examples herein, in particular example 1, wherein the motion sensor comprises an optical detector and a light source optically coupled to the optical detector.

Example 7 is an apparatus according to any examples herein, in particular example 2, wherein the motion sensor is a first motion sensor, and wherein a second motion sensor is positioned on or within the tunnel at a third distance from the first opening, and wherein the third distance is larger than the second distance, wherein the second motion sensor is coupled to the controller, and wherein the controller is operable to receive a third signal from the second motion sensor and send a fourth signal to the actuator.

Example 8 is an apparatus according to any examples herein, in particular example 7, wherein the second opening of the tunnel is bifurcated, wherein the tunnel comprises a fourth opening adjacent to the second opening, wherein a movable partition is adjacent to the second opening and to the fourth opening, wherein the movable partition is operable to block the second opening or the fourth opening.

Example 9 is an apparatus according to any examples herein, in particular example 8, wherein a metal detector is positioned on or within the tunnel, and wherein the metal detector is electronically coupled to the controller, wherein the controller is operable to receive a fifth signal from the metal detector and to send a sixth signal to the movable partition based upon the third signal.

Example 10 is an apparatus according to any examples herein, in particular example 1, further includes a tag extraction station, wherein the tag extraction station comprises a cranial punch, wherein the cranial punch is operable to extract cranial tissue from a fish.

Example 11 is an apparatus according to any examples herein, in particular example 1, wherein the tissue catchment is any one of a collection vessel, a multi-well plate, or a dry-storage card is disposed below the third opening.

Example 12 is a method for collecting tissue samples from a fish, comprising providing a tissue sampling apparatus, wherein the tissue sampling apparatus comprises a tunnel comprising a tubular body having a length extending between a first opening and a second opening of the tubular body, wherein the tunnel is tilted at an angle; a motion sensor positioned on or within the tunnel at a first distance from the first opening, wherein the first distance is a portion of the length; a punch comprising a shaft, wherein the punch comprises a tip and extends transversely into an interior region of the tunnel through a wall of the tunnel at a second distance from the first opening, wherein the second distance is larger than the first distance, and wherein the punch is coupled to an actuator coupled to an exterior surface of the wall of the tunnel; and an anvil coupled to the wall of the tunnel below the tip of the punch, wherein the anvil comprises a third opening aligned to an axis of the punch; gravity feeding the fish into the tunnel through the first opening, wherein the fish slides down the tunnel towards the second opening; activating the punch when the motion sensor detects passage of the fish, wherein the tip of the punch moves through the third opening in the anvil; removing a portion of a tissue of the fish; and storing the portion of the tissue of the fish.

Example 13 is a method according to any examples herein, in particular example 12, wherein activating the punch when the motion sensor detects the passage of the fish includes receiving a first signal from the motion sensor and sending a second signal to the actuator, wherein the actuator drives the punch toward the anvil.

Example 14 is a method according to any examples herein, in particular example 13, wherein receiving the first signal from the motion sensor and sending the second signal to the actuator includes receiving the first signal from the motion sensor and sending the second signal after a first time delay from a first initial time, wherein the first initial time corresponds to a rising edge of the first signal.

Example 15 is a method according to any examples herein, in particular example 14, wherein receiving the first signal from the motion sensor and sending the second signal to the actuator includes receiving the first signal from the motion sensor and sending the second signal after a second time delay from a second initial time, wherein the second initial time corresponds to a falling edge of the first signal.

Example 16 is a method according to any examples herein, in particular example 12, wherein removing the portion of the tissue from the fish comprises driving the tip of the punch through the tissue, wherein the portion of the tissue is cut from the tissue by the tip of the punch.

Example 17 is a method according to any examples herein, in particular example 12, wherein storing the portion of the tissue of the fish comprises removing the portion of the tissue from the tip of the punch and moving the portion of the tissue into a catchment below the third opening, wherein the catchment is any one of a collection vessel, a multi-well plate, a sample tube, or a dry-storage card.

Example 18 is a method according to any examples herein, in particular example 17, wherein removing the portion of the tissue from the tip of the punch includes blowing a pulse of air over the tip, wherein the pulse of air pushes the portion of the tissue off the tip, and wherein the portion of the tissue falls into the catchment.

Example 19 is a method according to any examples herein, in particular example 12, further includes detecting a tag implant within the fish; and activating a partition to block the second opening and to direct the fish to exit the tunnel through a fourth opening of the tunnel, wherein the fourth opening is adjacent to the second opening.

Example 20 is a method according to any examples herein, in particular example 19, further includes extracting the tag implant from the fish, wherein the tag implant is within a cranial portion of the fish, and extracting the tag implant from the fish includes extracting a portion of the cranial portion from the fish.

Besides what is described herein, various modifications can be made to the disclosed implementations and implementations thereof without departing from their scope. Therefore, illustrations of implementations herein should be construed as examples, and not restrictive to scope of present disclosure.

1. An apparatus, comprising:
a tunnel having a length extending between a first opening and a second opening, wherein the tunnel is tilted at an angle between 10 and 45 degrees;
a motion sensor positioned on or within the tunnel at a first distance from the first opening, wherein the first distance is a portion of the length;
a punch comprising a shaft, wherein the shaft comprises a tip at an end of the shaft, and extends transversely into an interior region of the tunnel through an upper wall of the tunnel at a second distance from the first opening, wherein the second distance is larger than the first distance and is positioned to enable tissue sampling from a fish sliding down the tilted tunnel, and wherein the punch is coupled to an actuator, and wherein the actuator is coupled to an exterior surface of the upper wall of the tunnel; and
an anvil coupled to the upper wall of the tunnel below the tip of the shaft, wherein the anvil comprises a third opening extending through a lower wall of the tunnel and aligned to an axis of the punch, wherein the lower wall is opposite to the upper wall, and wherein a tissue catchment is below the third opening.

2. The apparatus of claim 1, wherein a controller is electrically coupled to the motion sensor and to the actuator, wherein the controller is operable to receive a first signal from the motion sensor and send a second signal to the actuator upon reception of the first signal.

3. The apparatus of claim 2, wherein the actuator is a first pneumatic actuator attached to a movable stage, wherein the movable stage is coupled to the upper wall of the tunnel, and wherein the movable stage is coupled to a second pneumatic actuator coupled to the upper wall of the tunnel.

4. The apparatus of claim 3, wherein the controller is operable to send the second signal simultaneously to the first pneumatic actuator and to the second pneumatic actuator after a time delay.

5. The apparatus of claim 2, wherein the actuator is a linear actuator, wherein the controller is operable to send the second signal to a motor drive coupled to the linear actuator.

6. The apparatus of claim 1, wherein the motion sensor comprises an optical detector and a light source optically coupled to the optical detector.

7. The apparatus of claim 2, wherein the motion sensor is a first motion sensor, and wherein a second motion sensor is positioned on or within the tunnel at a third distance from the first opening, and wherein the third distance is larger than the second distance, wherein the second motion sensor is coupled to the controller, and wherein the controller is operable to receive a third signal from the second motion sensor and send a fourth signal to the actuator.

8. The apparatus of claim 7, wherein the second opening of the tunnel is bifurcated, wherein the tunnel comprises a fourth opening adjacent to the second opening, wherein a movable partition is adjacent to the second opening and to the fourth opening, wherein the movable partition is operable to block the second opening or the fourth opening.

9. The apparatus of claim 8, wherein a metal detector is positioned on or within the tunnel, and wherein the metal detector is electronically coupled to the controller, wherein the controller is operable to receive a fifth signal from the metal detector and to send a sixth signal to the movable partition based upon the third signal.

10. The apparatus of claim 1, further includes a tag extraction station, wherein the tag extraction station comprises a cranial punch, wherein the cranial punch is operable to extract cranial tissue from a fish.

11. The apparatus of claim 1, wherein the tissue catchment is any one of a collection vessel, a multi-well plate, or a dry-storage card is disposed below the third opening.

12. A method for collecting tissue samples from a fish, comprising:
providing a tissue sampling apparatus, wherein the tissue sampling apparatus comprises:
a tunnel comprising a tubular body having a length extending between a first opening and a second opening of the tubular body, wherein the tunnel is tilted at an angle between 10 and 45 degrees;
a motion sensor positioned on or within the tunnel at a first distance from the first opening, wherein the first distance is a portion of the length;
a punch comprising a shaft, wherein the punch comprises a tip and extends transversely into an interior region of the tunnel through a wall of the tunnel at a second distance from the first opening, wherein the second distance is larger than the first distance and is positioned to enable tissue sampling from a fish sliding down the tilted tunnel, and wherein the punch is coupled to an actuator coupled to an exterior surface of the wall of the tunnel; and
an anvil coupled to the wall of the tunnel below the tip of the punch, wherein the anvil comprises a third opening aligned to an axis of the punch;
gravity feeding the fish into the tunnel through the first opening, wherein the fish slides down the tunnel towards the second opening;
activating the punch when the motion sensor detects passage of the fish, wherein the tip of the punch moves through the third opening in the anvil;
removing a portion of a tissue of the fish; and
storing the portion of the tissue of the fish.

13. The method of claim 12, wherein activating the punch when the motion sensor detects the passage of the fish includes receiving a first signal from the motion sensor and sending a second signal to the actuator, wherein the actuator drives the punch toward the anvil.

14. The method of claim 13, wherein receiving the first signal from the motion sensor and sending the second signal to the actuator includes receiving the first signal from the motion sensor and sending the second signal after a first time delay from a first initial time, wherein the first initial time corresponds to a rising edge of the first signal.

15. The method of claim 14, wherein receiving the first signal from the motion sensor and sending the second signal to the actuator includes receiving the first signal from the motion sensor and sending the second signal after a second time delay from a second initial time, wherein the second initial time corresponds to a falling edge of the first signal.

16. The method of claim 12, wherein removing the portion of the tissue from the fish comprises driving the tip of the punch through the tissue, wherein the portion of the tissue is cut from the tissue by the tip of the punch.

17. The method of claim 12, wherein storing the portion of the tissue of the fish comprises removing the portion of the tissue from the tip of the punch and moving the portion of the tissue into a catchment below the third opening, wherein the catchment is any one of a collection vessel, a multi-well plate, a sample tube, or a dry-storage card.

18. The method of claim 17, wherein removing the portion of the tissue from the tip of the punch includes blowing a pulse of air over the tip, wherein the pulse of air pushes the portion of the tissue off the tip, and wherein the portion of the tissue falls into the catchment.

19. The method of claim 12, further includes:
detecting a tag implant within the fish; and
activating a partition to block the second opening and to direct the fish to exit the tunnel through a fourth opening of the tunnel, wherein the fourth opening is adjacent to the second opening.

20. The method of claim 19, further includes extracting the tag implant from the fish, wherein the tag implant is within a cranial portion of the fish, and extracting the tag implant from the fish includes extracting a portion of the cranial portion from the fish.
